(19) United States
(12) Patent Application Publication
(10) Pub. No.: US 2014/0192925 A1
(43) Pub. Date: Jul. 10, 2014

(54) METHOD OF AND APPARATUS FOR REDUCING PAPR IN FILTER-BANK MULTI-CARRIER SYSTEM

(71) Applicant: Dong Li, Shanghai (CN)

(72) Inventor: Dong Li, Shanghai (CN)

(73) Assignee: ALCATEL LUCENT, Paris (FR)

(21) Appl. No.: 14/234,729

(22) PCT Filed: Jul. 13, 2012
(86) PCT No.: PCT/IB2012/001452

§ 371 Date: Jan. 24, 2014

(30) Foreign Application Priority Data
Jul. 29, 2011 (CN) 201110217534.6

(51) Int. Cl. H04L 27/34; H04L 25/08; H04L 27/38; H04L 27/36

(52) U.S. Cl. CPC H04L 27/3411; H04L 27/362; H04L 25/08; H04L 27/38
USPC 375/297; 375/320

(57) ABSTRACT

The invention relates to a method of reducing Peak-to-Average. Power Ratio in a transmitting device of a filter-hank multi-carrier system, which includes the steps of: performing constellation modulation (210) on data to be transmitted; performing K-point Discrete Fourier Transform (220) on a vector composed of K constellation symbols resulting from the constellation modulation: and performing Offset-Quadrature Amplitude Modulation (230) on a data vector resulting from the Discrete Fourier Transform, wherein the parameter K represents the number of subcarriers allocated for transmission of the data to be transmitted. With the solution proposed by the invention. PAPR of a signal can be significantly reduced without adding a large number of operations to thereby improve the efficiency of a power amplification circuit, to improve effective transmission, power and to alleviate nonlinear distortion of the signal during a power amplification.

### FIELD OF THE INVENTION

The present disclosure relates to a wireless communication network and particularly to a method of reducing Peak-to-Average Power Ratio in a filter-bank multi-carrier system.

### BACKGROUND OF THE INVENTION

Quadrature Frequency Division Multiplexing (OFDM) was used in the 4G mobile communication system. However the application of the OFDM system is limited due to the drawbacks of large out-of-band emission, a considerable guard band overhead and a limited frequency resolution of OFDM. A Filter-Bank Multi-Carrier (FBMC) system is promising to become an alternative solution to OFDM due to the rapid out-of-band attenuation of its subcarrier spectrum and little interference to an adjacent subcarrier.

Furthermore the FBMC system also has the advantages of an omitted cyclic prefix, improved spectrum efficiency, robustness to a time and frequency synchronization error, etc.

Unfortunately the FMBC suffers from the problem of the high Peak-to-Average Power Ratio (PAPR) of the transmitted signal. High Peak-to-Average Power Ratio tends to cause increased power consumption, which may be very adverse, especially at a user equipment. Besides, high Peak-to-Average Power Ratio further tends to cause nonlinear distortion for the transmitted signal during a power amplification phase, which has to be avoided as well.

### SUMMARY OF THE INVENTION

An object of the invention is to provide a method of reducing Peak-to-Average Power Ratio in a filter-bank multi-carrier system, which will be very beneficial.

According to an aspect of the invention, there is proposed a method of reducing Peak-to-Average Power Ratio in a transmitting device of a filter-bank multi-carrier system, which comprises the steps of: performing constellation modulation on data to be transmitted; performing K-point Discrete Fourier Transform on a vector composed of K constellation symbols resulting from the constellation modulation; and performing Offset-Quadrature Amplitude Modulation on a data vector resulting from the Discrete Fourier Transform, wherein the parameter K represents the number of subcarriers allocated for transmission of the data to be transmitted.

Furthermore the step of Offset-Quadrature Amplitude Modulation comprises mapping a real part of the data vector to a first filter-bank multi-carrier symbol mapping and an imaginary part of the data vector to a second filter-bank multi-carrier symbol.

Still furthermore a phase comprised in each element of the first and second filter-bank multi-carrier symbols is determined by a time-domain index of the filter-bank multi-carrier symbol to which the element is belonging and a frequency-domain index of a corresponding subcarrier.

According to another aspect of the invention, there is proposed a method of reducing Peak-to-Average Power Ratio in a receiving device of a filter-bank multi-carrier system, which comprises the steps of: performing Offset-Quadrature Amplitude Modulation demodulation on a signal after channel equalization; performing K-point Inverse Discrete Fourier Transform on the signal after the Offset-Quadrature Amplitude Modulation demodulation; and performing constellation modulation demodulation on the signal after the Inverse Discrete Fourier Transform, wherein the parameter K represents the number of subcarriers allocated for transmission of corresponding data to be transmitted.

According to another aspect of the invention, there is proposed an apparatus for reducing Peak-to-Average Power Ratio in a transmitting device of a filter-bank multi-carrier system, which comprises: a constellation modulation device configured to perform constellation modulation on data to be transmitted; a Discrete Fourier Transform device configured to perform K-point Discrete Fourier Transform on a vector composed of K constellation symbols resulting from the constellation modulation; and an Offset-Quadrature Amplitude Modulation device configured to perform Offset-Quadrature Amplitude Modulation on a data vector resulting from the Discrete Fourier Transform, wherein the parameter K represents the number of subcarriers allocated for transmission of the data to be transmitted.

According to another aspect of the invention, there is proposed an apparatus for reducing Peak-to-Average Power Ratio in a receiving device of a filter-bank multi-carrier system, which comprises: an Offset-Quadrature Amplitude Modulation demodulation device configured to perform Offset-Quadrature Amplitude Modulation demodulation on a signal after is channel equalization; an Inverse Discrete Fourier Transform device configured to perform K-point Inverse Discrete Fourier Transform on the signal after the Offset-Quadrature Amplitude Modulation demodulation; and a constellation modulation demodulation device configured to perform constellation modulation demodulation on the signal after the Inverse Discrete Fourier Transform, wherein the parameter K represents the number of subcarriers allocated for transmission of corresponding data to be transmitted.

With the solution proposed in the invention, Peak-to-Average Power Ratio of a signal can be significantly reduced without adding a large number of operations. Thus the efficiency of a power amplification circuit and the effective transmission power can be increased and the nonlinear distortion of the signal during a power amplification phase can be decreased. Furthermore the solution of an Offset-Quadrature Amplitude Modulation has been further optimized with the solution proposed in the invention. Such an optimized Offset-Quadrature Amplitude Modulation solution can achieve optimum Peak-to-Average Power Ratio after the introduction of Discrete Fourier Transform.

### BRIEF DESCRIPTION OF DRAWINGS

Preferred embodiments of the invention will be described below in further details by way of examples with reference to the drawings in which:

FIG. 1 illustrates a signal flow chart in a transmitting device of an existing FBMC system;

FIG. 2 illustrates a signal flow chart in a transmitting device of a FBMC system according to an embodiment of the invention;

FIG. 3 illustrates a signal flow chart of multi-carrier filtering in the embodiment illustrated in FIG. 2;

FIG. 4 illustrates a signal flow chart of an OQAM modulation scheme according to an embodiment of the invention;

FIG. 5 illustrates a signal flow chart of a polyphase filterer according to is an embodiment of the invention;

FIG. 6 illustrates a signal flow chart in a receiving device of a FBMC system according to another embodiment of the invention;

FIG. 7 illustrates a signal flow chart of multi-carrier filtering in the embodiment illustrated in FIG. 6;

FIG. 8 illustrates a signal flow chart of the OQAM demodulation scheme corresponding to the embodiment illustrated in FIG. 4;

FIG. 9 illustrates a signal flow chart of the polyphase filter corresponding to the embodiment illustrated in FIG. 5;

FIG. 10 illustrates an apparatus for reducing Peak-to-Average Power Ratio in a transmitting device of a FBMC system according to an embodiment of the invention; and

FIG. 11 illustrates an apparatus for reducing Peak-to-Average Power Ratio in a receiving device of a FBMC system according to an embodiment of the invention.

Identical or similar reference numerals denote identical or similar step features or devices (modules).

### DETAILED DESCRIPTION OF EMBODIMENTS

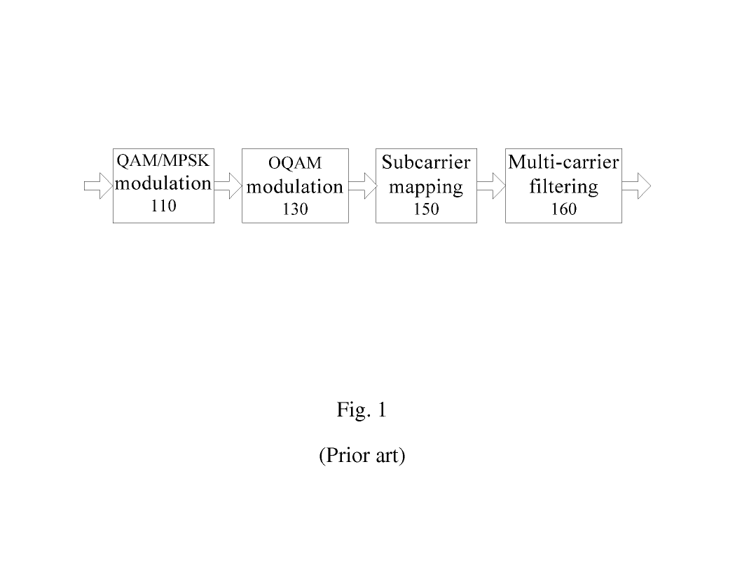

Embodiments of the invention will be described below in detail by way of examples with reference to the drawings. FIG. 1 illustrates a signal flow chart in a transmitting device of an existing FBMC system. As illustrated, in the existing FBMC system, constellation modulation 110 is firstly performed on data to be transmitted after channel encoding is performed on the information bits. The scheme of the constellation-modulated 110 may be Multiple Phase-Shift Keying (MPSK), or Quadrature Amplitude Modulation (QAM), etc., for converting the data bits into constellation symbols. Then a serial-to-parallel conversion (not illustrated) is performed on the resulted constellation symbols. Offset-Quadrature Amplitude Modulation (OQAM) 103 is performed on a vector composed of K constellation symbols, wherein the parameter K is represents the number of subcarriers allocated for transmission of the data to be transmitted. Subsequent to the OQAM modulation, the vector composed of the K constellation symbols is mapped to two FBMC symbols. There are a variety of OQAM modulation schemes available in the prior art. Thereafter the FBMC symbols are mapped to corresponding subcarriers through subcarrier mapping 150. Thereafter multi-carrier filtering 160 is performed on the output of the subcarrier mapping.

Furthermore the multi-carrier filtering 160 further comprises performing M-point Inverse Discrete Fourier Transform on the output of the subcarrier mapping 150 and performing a polyphase filtering process on the signal after the Inverse Discrete Fourier Transform. Here the parameter M represents the total number of subcarriers of the system. A step of performing channel encoding on the data to be transmitted may be further included before the constellation modulation 110.

As mentioned earlier, the existing FBMC system suffers from the problem of high Peak-to-Average Power Ratio. In order to address the problem in the prior art, a method of reducing Peak-to-Average Power Ratio in a transmitting device of a FMBC system is proposed according to an embodiment of the invention, and a signal flow chart thereof is as illustrated in FIG. 2.

This embodiment of the invention will be described below in non-limiting details with reference to FIG. 2. As illustrated in FIG. 2, the step of performing a K-point DFT process 220 on a signal is added between the constellation modulation 210 and the OQAM modulation 230 according to this embodiment of the invention.

Specifically, the constellation modulation 210 is firstly performed on the data to be transmitted. The scheme of modulation can be MPSK, or QAM, etc., for converting the data bits into constellation symbols. As can be appreciated, the step of performing channel decoding on the data to be transmitted can further be included before the constellation modulation 210. After the constellation modulation 210, a serial-to-parallel conversion (not is illustrated) is performed on the resulted constellation symbols. A vector S is composed of K constellation symbols sᵢ with i=0, 1, . . . , K−1 resulted from the constellation modulation 210, wherein the parameter K represents the number of subcarriers allocated for transmission of the data to be transmitted. Data constellation symbols corresponding to the 2n-th and 2n+1-th FBMC symbols can be represented as:

$$S • [ \begin{matrix}{s}_{0} \\ {s}_{1} \\ ⋮ \\ {s}_{K •1}\end{matrix} ] \qquad ( 1 )$$

Then K-point DFT pre-coding 220 is performed on the vector, and the data vector after the DFT pre-coding 220 can be represented as:

$$X • [ \begin{matrix}{x}_{0} \\ {x}_{1} \\ ⋮ \\ {x}_{K • 1}\end{matrix} ] • \frac{1}{\sqrt{K}} • [ \begin{matrix}1 & 1 & … & 1 \\ 1 & {W}_{K} & … & {W}_{K}^{K • 1} \\ ⋮ & ⋮ & ⋱ & ⋮ \\ 1 & {W}_{K}^{K • 1} & … & {W}_{K}^{{( K • 1 )}^{2}}\end{matrix} ] [ \begin{matrix}{S}_{0} \\ {S}_{1} \\ ⋮ \\ {S}_{K • 1}\end{matrix} ] \qquad ( 2 )$$

Wherein 1/\sqrt{K} represents a power normalization factor in the DFT pre-coding and W_{K} represents e^{␣j2␣/K}.

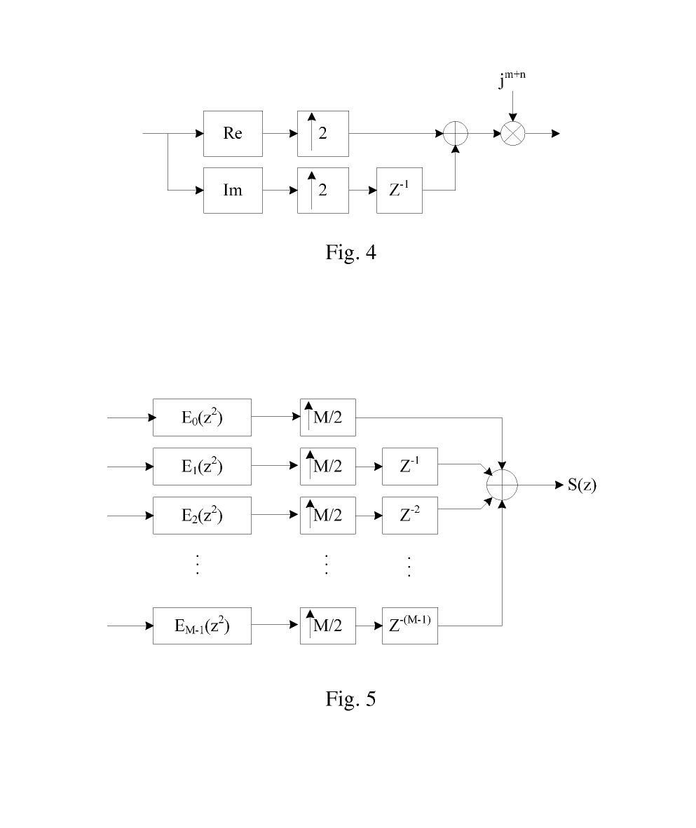

Then the OQAM modulation 230 is performed on the resulted data vector X. The data vector X will be split into two FBMC symbols in the OQAM modulation 230. A scheme of OQAM modulation is selected according to a preferred embodiment of the invention. FIG. 4 illustrates a signal flow chart of an OQAM modulation scheme according to a preferred embodiment of the invention. As illustrated, the real and imaginary parts of each element x in the data vector X are firstly separated so that subsequently the real part of the data vector X is mapped to a first FBMC symbol X₂ₙ and the imaginary part of the data vector is mapped to a second FBMC symbol X₂ₙ₊₁. The resulted real components R{x} and imaginary components I{x} are up-sampled respectively by a factor of 2. Particularly the up-sampled real components R{x} are added to the signal of the up-sampled imaginary components I{x } going through a delay element. Then their sum is output after a phase process, so that a data vector X is decomposed into two FBMC is symbols output sequentially in time. Those skilled in the art could appreciate that the first and second FBMC symbols X₂ₙ and X₂ₙ₊₁ may overlap in time by a length which will be determined by the prototype filter response. A phase comprised in each element of the first and second FBMC symbols is determined by a time-domain index of the FBMC symbol to which the element is belonging and a frequency-domain index of the corresponding subcarrier. In this preferred embodiment, a phase included in each element of the first and second FBMC symbols X₂ₙ and X₂ₙ₊₁ is determined by the sum of the time-domain index 2n or 2n+1 of the FBMC symbol to which the element is belonging and the frequency-domain index k₀ to k_{K-1} of the corresponding subcarrier. That is, the factor multiplied in the phase process is exp(j*pi/2*(the sum of the indexes)), i.e., the order of the imaginary number unit j is the sum of the indexes.

The 2n-th and 2n+1-th FBMC symbols resulted from the process of OQAM modulation 230 can be represented as:

$$\begin{matrix}{X}_{2 n} {•j}^{2 n • {k}_{0}} • [ \begin{matrix}R \{ {x}_{0} \} \\ j • R \{ {x}_{1} \} \\ • R \{ {x}_{2} \} \\ • j • R \{ {x}_{3} \} \\ ⋮ \\ j• R \{ {x}_{K • 1} \}\end{matrix} ] & ( 3 ) \\ {X}_{2 n • 1} • {j}^{2 n • 1 • {k}_{0}} • [ \begin{matrix}I \{ {x}_{0} \} \\ j • I \{ {x}_{1} \} \\ • I \{ {x}_{2} \} \\ • j • I \{ {x}_{3} \} \\ ⋮ \\ • j • I \{ {x}_{K • 1} \}\end{matrix} ] • {j}^{2 n • {k}_{0}} • [ \begin{matrix}j • I \{ {x}_{0} \} \\ • I \{ {x}_{1} \} \\ • j • I \{ {x}_{2} \} \\ I \{ {x}_{3} \} \\ ⋮ \\ I \{ {x}_{K • 1} \}\end{matrix} ] & ( 4 )\end{matrix}$$

Here the symbol j denotes the imaginary number unit and k₀ denotes an initial index of the transmission bandwidth for the data to be transmitted. Here K is assumed to be integer times of 4 without loss of generality. The allocated K subcarriers are successive in this preferred embodiment. Those skilled in the art could appreciate that this is not essential for the implementation of the invention. It is also possible if the allocated K subcarriers are not successive, for example, the indexes of the allocated K subcarriers are k₁, k₃, k, . . . , k_{2K-1}.

Then the first and second FBMC symbols X₂ₙ and X₂ₙ₊₁ are mapped to the allocated K subcarriers through the subcarrier mapping 250. In a preferred embodiment of the invention, the frequency-domain index of the initial subcarrier is assumed to be k₀=0, and subcarrier mapping 250 can be expressed as:

$$\begin{matrix}{\overline{X}}_{2 n} ( k ) • \{ \begin{matrix}{X}_{2 n} ( k ) , & k • 0 , 1 , … , K • 1 \\ 0 , & k • K , K • 1 , … , M • 1\end{matrix} & ( 5 ) \\ {\overline{X}}_{2 n • 1} ( k ) • \{ \begin{matrix}{X}_{2 n • 1} ( k ) , & k • 0 , 1 , … , K • 1 \\ 0 , & k • K , K • 1 , … , M • 1\end{matrix} & ( 6 )\end{matrix}$$

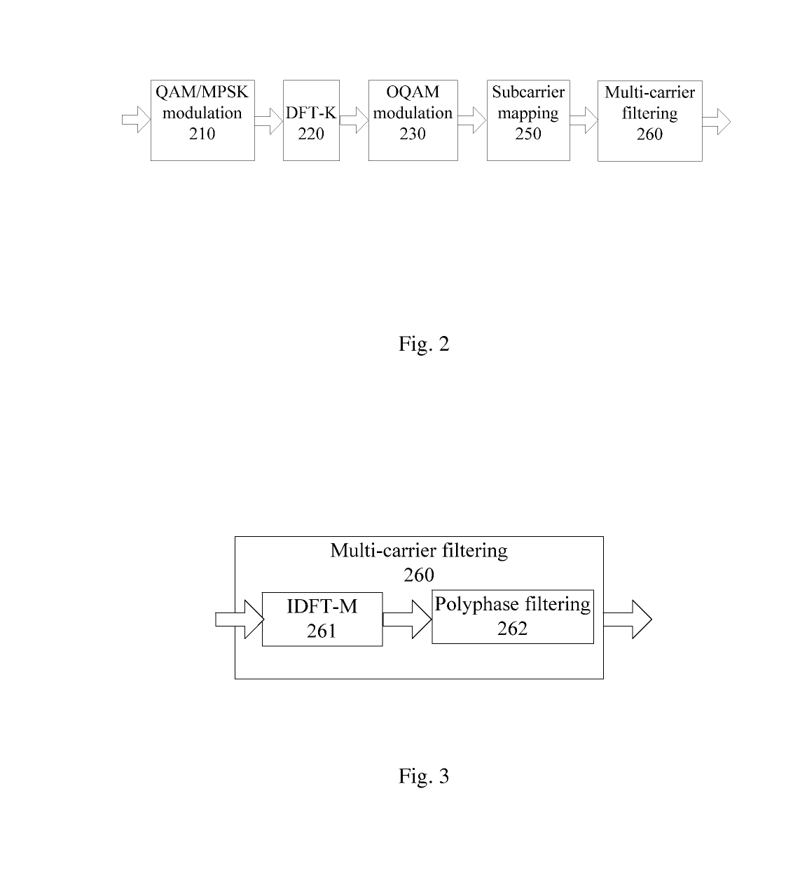

Then the multi-carrier filtering 260 is performed on the output of the subcarrier mapping X̅₂ₙ(k) and X̅_{2n□l}(k). As illustrated in FIG. 3, the multi-carrier filtering 260 further comprised performing M-point IDFT transform 261 on the output of the subcarrier mapping X̅₂ₙ(k) and X̅₂ₙ₊₁(k) and performing polyphase filtering 262 on the signal after the IDFT, wherein the parameter M represents the total number of subcarriers in the FBMC system.

FIG. 5 illustrates a signal flow chart of a polyphase filterer according to an embodiment of the invention. Since the presented scheme is well known to those skilled in the art, a detailed description thereof will be omitted here. Furthermore those skilled in the art could appreciate that the polyphase filtering scheme presented here is merely illustrative and intended for a full description of the processing on a signal in the FMBC system but shall not be taken as a limit to the scope of the invention. A specific implementation of polyphase filtering is not an important aspect of the invention, and it is possible to use other multi-carrier filtering schemes which can occur to those skilled in the art.

The transmission signal resulted in this embodiment of the invention is will further be analyzed to demonstrate an effective reduction of the Peak-to-Average Power Ratio of the transmission signal resulted in the solution of the invention.

Specifically the IDFT output for the 2n-th FBMC symbol can be expressed as:

$$\begin{matrix}{\overline{\overline{X}}}_{2 n} ( m ) = \frac{\sqrt{B}}{\sqrt{M}} {\sum }_{k = 0}^{M - 1} {\overline{X}}_{2 n} ( k ) \cdot {e}^{j 2 π \frac{m}{M} k} \\ = \frac{1}{\sqrt{K}} \cdot {\sum }_{k = 0}^{K - 1} {X}_{2 n} ( k ) \cdot {e}^{j 2 π \frac{m}{M} k} \\ = \frac{1}{\sqrt{K}} \cdot {\sum }_{k = 0}^{K - 1} R \{ {x}_{k} \} {e}^{j π k / 2} \cdot {e}^{j 2 π \frac{m}{M} k}\end{matrix} \qquad ( 7 )$$

Here, the term \sqrt{B}/\sqrt{M}=1/\sqrt{K} is for output power normalization. Let m=pB+q, where 0≦q<B and 0≦p<M/B=K, then equation (7) can be represented as:

$${\overline{\overline{X}}}_{2 n} ( m ) = \frac{1}{\sqrt{K}} \cdot {\sum }_{k = 0}^{K - 1} R \{ {x}_{k} \} {e}^{j π k / 2} \cdot {e}^{\frac{j 2 π ( pB + q ) k}{BK}} \qquad ( 8 )$$

1) When q=0, i.e., for m=pB:

$$\begin{matrix}{\overline{\overline{X}}}_{2 n} ( m ) = \frac{1}{\sqrt{K}} \cdot {\sum }_{k = 0}^{K - 1} R \{ {x}_{k} \} {e}^{j π k / 2} \cdot {e}^{\frac{j 2 π pk}{K}} \\ = \frac{1}{\sqrt{K}} \cdot {\sum }_{k = 0}^{K - 1} R \{ {x}_{k} \} {e}^{\frac{j 2 π ( p + K / 4 ) k}{K}}\end{matrix} \qquad ( 9 )$$

The following relationship can be derived from the equation (2) according to the DFT transform property:

$$\begin{matrix}\begin{matrix}{S}_{ep} ( n ) = \frac{1}{\sqrt{K}} {\sum }_{k = 0}^{K - 1} R \{ {x}_{k} \} {e}^{j π nk / K} \\ = \frac{1}{2} ( {s}_{n} + {s}_{{( ( K - n ) )}_{K}}^{*} ) , n = 0 , 1 , … , K - 1\end{matrix} & ( 10 ) \\ \begin{matrix}{S}_{op} ( n ) = \frac{1}{\sqrt{K}} {\sum }_{k = 0}^{K - 1} j \cdot I \{ {x}_{k} \} \cdot {e}^{j π nk / K} \\ = \frac{1}{2} ( {s}_{n} - {s}_{{( ( K - n ) )}_{K}}^{*} ) , n = 0 , 1 , … , K - 1\end{matrix} & ( 11 )\end{matrix}$$

Here s((n))_{K} denotes the extension sequence with a period K for the finite-length sequence of s(n).

According to equations (9) and (10) it can be calculated that:

$$\begin{matrix}{\overline{\overline{X}}}_{2 n} ( pB ) = {{S}_{ep} ( ( p + K / 4 ) )}_{K} \\ = \frac{1}{2} ( {s}_{{( ( p + K / 4 ) )}_{K}} + {s}_{{( ( 3 K / 4 - p ) )}_{K}}^{*} ) , 0 \leq p < K\end{matrix} \qquad ( 12 )$$

[symbol] ₑₚ(p)=Sₑₚ((p+K/4))_{K} is defined and referred to as a Quarterly-Shifted Circular Conjugate Symmetric Sequence (QS-CCSS).

2) When q≠0, i.e., for m=pB+q, the equation (10) is translated into

$$R \{ {x}_{k} \} {e}^{j π k / 2} = \frac{1}{\sqrt{K}} {\sum }_{k = 0}^{K - 1} {{S}_{ep} ( ( l + K / 4 ) )}_{K} \cdot {e}^{- j 2 π kl} \qquad ( 13 )$$

The equation (13) is substituted into (7) resulting in:

$$\begin{matrix}{\overline{\overline{X}}}_{2 n} ( m ) = \frac{1}{\sqrt{K}} \cdot {\sum }_{k = 0}^{K - 1} R \{ {x}_{k} \} {e}^{j π k / 2} \cdot {e}^{\frac{j 2 π ( pB + q ) k}{BK}} \\ = \frac{1}{K} \cdot {\sum }_{k = 0}^{K - 1} ( {\sum }_{l = 0}^{K - 1} {\overleftarrow{S}}_{ep} ( l ) \cdot {e}^{- j 2 π kl / K} ) \cdot {e}^{\frac{j 2 π ( pB + q ) k}{BK}} \\ = \frac{1}{K} \cdot {\sum }_{k = 0}^{K - 1} {\overleftarrow{S}}_{ep} ( l ) ( {\sum }_{k = 0}^{K - 1} {e}^{j 2 π ( \frac{p - l}{K} + \frac{q}{BK} ) k} ) \\ = \frac{1}{K} \cdot {\sum }_{k = 0}^{K - 1} {\overleftarrow{S}}_{ep} ( l ) \cdot \frac{1 - {e}^{j 2 π \frac{q}{B}}}{1 - {e}^{j 2 π ( \frac{p - l}{K} + \frac{q}{BK} )}}\end{matrix} \qquad ( 14 )$$

As can be apparent from the equations (12) and (14), the time-domain output signal of the 2n-th FBMC symbol after IDFT transform is composed of the QS-CCSS sequence and an interpolation sequence thereof according to the solution of the invention. The QS-CCSS sequence itself is a superposition of two sequences of constellation modulation symbols, and therefore the Peak-to-Average Power Ratio of the output signal is greatly reduced as compared with the traditional multi-carrier signal.

The IDFT output for the 2n+1-th FBMC symbol can be expressed as:

$$\begin{matrix}{\overline{\overline{X}}}_{2 n + 1} ( m ) = \frac{\sqrt{B}}{\sqrt{M}} {\sum }_{k = 0}^{M - 1} {\overline{X}}_{2 n + 1} ( k ) \cdot {e}^{j 2 π \frac{m}{M} k} \\ = \frac{1}{\sqrt{K}} \cdot {\sum }_{k = 0}^{K - 1} j \cdot I \{ {x}_{k} \} {e}^{j π k / 2} \cdot {e}^{j 2 π \frac{m}{M} k}\end{matrix} \qquad ( 15 )$$

Let m=pB+q, where 0≦q<B and 0≦p<M/B=K, and then:

1) When q=0, i.e., for m=pB, the equations (11) and (15) can be translated into:

$$\begin{matrix}{\overline{\overline{X}}}_{2 n + 1} ( pB ) = {{S}_{op} ( ( p + K / 4 ) )}_{K} \\ = \frac{1}{2} ( {s}_{{( ( p + K / 4 ) )}_{K}} - {s}_{{( ( 3 K / 4 - p ) )}_{K}}^{*} ) , 0 \leq p < K\end{matrix} \qquad ( 16 )$$

[symbol] ₒₚ(p)=Sₒₚ((p+K/4))_{K} is defined and referred to as a Quarterly-Shifted is Circular Conjugate Symmetric Sequence (QS-CCSS).

2) When q≠0, i.e., for m=pB+q, then:

$$\begin{matrix}{\overline{\overline{X}}}_{2 n + 1} ( m ) = \frac{1}{\sqrt{K}} \cdot {\sum }_{k = 0}^{K - 1} j \cdot I \{ {x}_{k} \} {e}^{j π k / 2} \cdot {e}^{\frac{j 2 π ( pB + q ) k}{BK} k} \\ = \frac{1}{\sqrt{K}} \cdot {\sum }_{k = 0}^{K - 1} {\overleftarrow{S}}_{op} ( l ) \cdot \frac{1 - {e}^{j 2 π \frac{q}{B}}}{1 - {e}^{j 2 π ( \frac{p - l}{K} + \frac{q}{BK} )}}\end{matrix} \qquad ( 17 )$$

As can be apparent from the equation (17), the time-domain output signal of the 2n+1-th FBMC symbol after IDFT transform is composed of the QS-CCAS sequence and an interpolation sequence thereof in the solution of the invention. The QS-CCAS sequence itself is a superposition of two sequences of constellation modulation symbols, and therefore the Peak-to-Average Power Ratio of the output signal is greatly reduced as compared with the traditional multi-carrier signal.

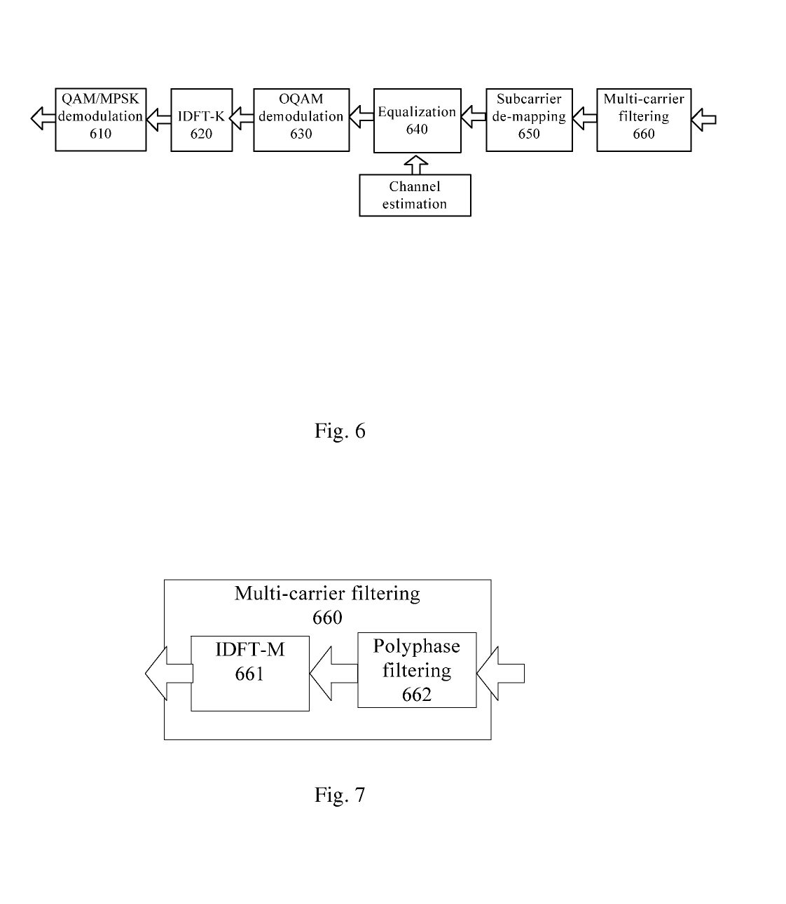

FIG. 6 illustrates a signal flow chart in a receiving device of a FBMC system according to another embodiment of the invention. Corresponding to the transmitting device, a receiving device firstly performs the multi-carrier filtering 660 on a received signal upon reception of the signal; then performs subcarrier inverse mapping 650 on the signal after the multi-carrier filtering; and then performs channel equalization 640 on the signal after the subcarrier inverse mapping. Those skilled in the art shall appreciate that a channel estimation will be performed before the channel equalization 640. Then the OQAM demodulation 630 is performed on the signal after the channel equalization; K-point IDFT transform 620 is performed on the signal after the OQAM demodulation; and then the constellation modulation demodulation 610 is performed on the signal after the IDFT process. Here the scheme of the constellation modulation is Multiple Phase-Shift Keying or Quadrature Amplitude Modulation. Furthermore corresponding to the transmitting device, the parameter K represents the number of subcarriers allocated in the transmitting device for the transmission of the corresponding data to be transmitted and correspondingly represents the number of subcarriers used for the received signal in the receiving device. Furthermore channel decoding on the signal after the constellation modulation demodulation can further be included after the constellation modulation demodulation 610.

FIG. 7 illustrates a signal flow chart of the multi-carrier filtering in the embodiment illustrated in FIG. 6. As illustrated in FIG. 7, the multi-carrier filtering 660 further comprising performing polyphase filtering 662 on the received signal and performing M-point inverse Discrete Fourier Transform 661 on the signal after the polyphase filtering, where the parameter M represents the total number of subcarriers in the filter-bank multi-carrier system.

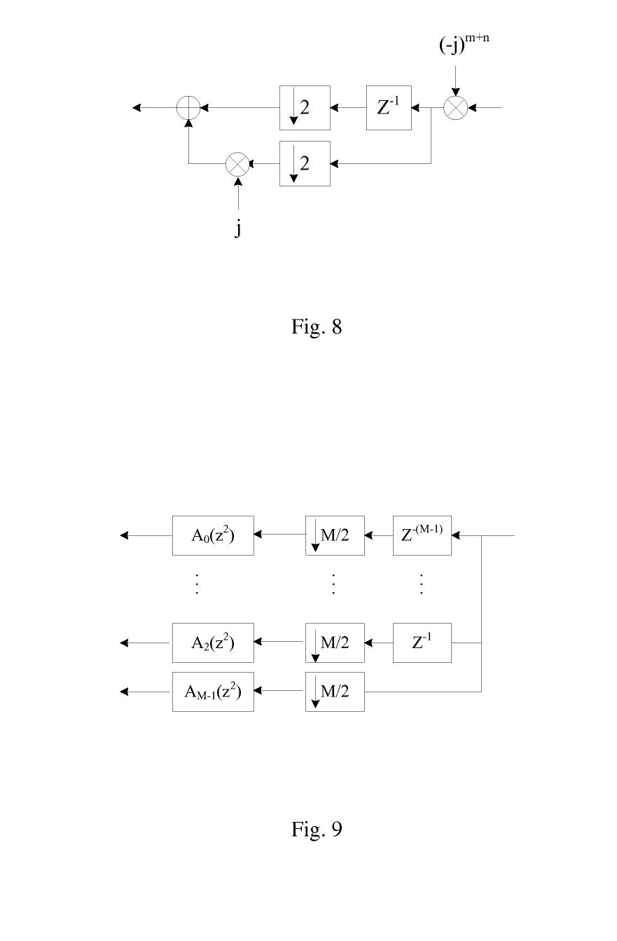

FIG. 8 illustrates a signal flow chart of OQAM demodulation corresponding to the OQAM modulation scheme adopted in the transmitting device. Signals detected on the FBMC symbols X₂ₙ and X₂ₙ₊₁ after the OQAM demodulation can be represented as:

$$\begin{matrix}{\hat{X}}_{2 n} = [ \begin{matrix}R \{ {x}_{0} \} \\ R \{ {x}_{1} \} \\ R \{ {x}_{2} \} \\ R \{ {x}_{3} \} \\ ⋮ \\ R \{ {x}_{K - 1} \}\end{matrix} ] + {\hat{W}}_{2 n} & ( 18 ) \\ {\hat{X}}_{2 n + 1} = [ \begin{matrix}I \{ {x}_{0} \} \\ I \{ {x}_{1} \} \\ I \{ {x}_{2} \} \\ I \{ {x}_{3} \} \\ ⋮ \\ I \{ {x}_{K - 1} \}\end{matrix} ] + {\hat{W}}_{2 n + 1} & ( 19 )\end{matrix}$$

After the K-point IDFT transform 620 is performed on the signal after the process of the OQAM demodulation 630, the original data symbol can be estimated as:

$$\begin{matrix}\hat{S} = \sqrt{K} \cdot IFFT ( [ \begin{matrix}R \{ {x}_{0} \} \\ R \{ {x}_{1} \} \\ R \{ {x}_{2} \} \\ R \{ {x}_{3} \} \\ ⋮ \\ R \{ {x}_{K - 1} \}\end{matrix} ] + j [ \begin{matrix}I \{ {x}_{0} \} \\ I \{ {x}_{1} \} \\ I \{ {x}_{2} \} \\ I \{ {x}_{3} \} \\ ⋮ \\ I \{ {x}_{K - 1} \}\end{matrix} ] + {\hat{W}}_{2 n} + j {\hat{W}}_{2 n + 1} ) \\ = S + \tilde{W}\end{matrix} \qquad ( 20 )$$

As can be apparent, there is limited calculation complexity resulting from the K-point IFFT in the data detection. Thus in the receiving device of the FBMC system, the decoding operation complexity resulting from the DFT pre-coding in the transmitting device is not too much.

FIG. 9 illustrates a signal flow chart of the polyphase filterer corresponding to the embodiment illustrated in FIG. 5. Since the presented scheme is well known to those skilled in the art, a detailed description thereof will be omitted here. Furthermore those skilled in the art should appreciate that the polyphase filtering scheme presented here is merely illustrative and intended for a full description of the processing on a signal in the FMBC system but shall not be taken as a limit to the scope of the invention. A specific implementation of polyphase filtering is not an important aspect of the invention, and it is possible to use other multi-carrier filtering schemes which can occur to those skilled in the art.

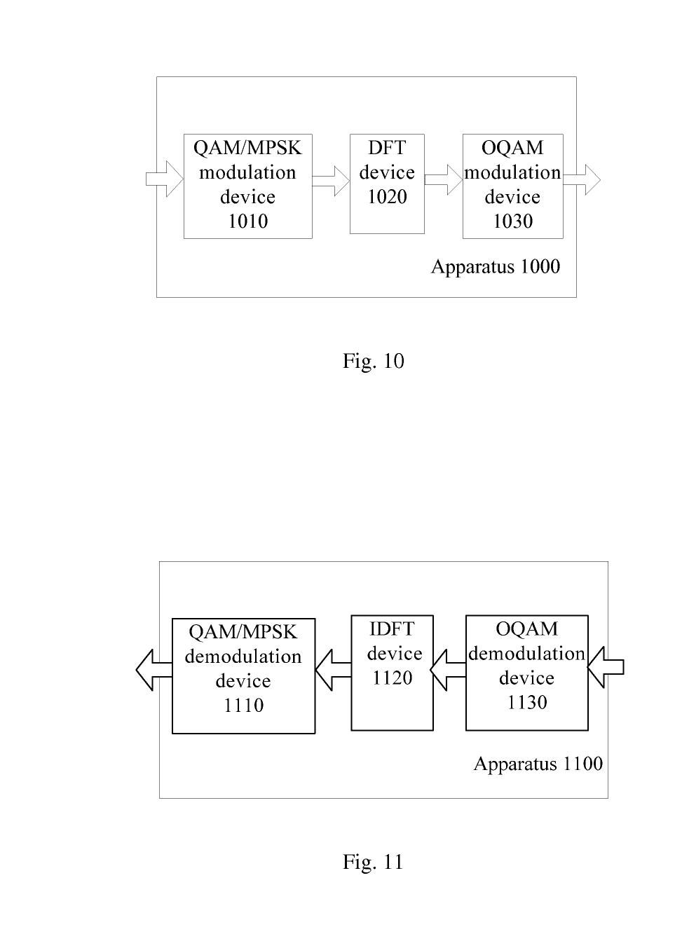

FIG. 10 illustrates an apparatus 1000 for reducing Peak-to-Average Power Ratio in a transmitting device of a FBMC system according to an embodiment of the invention, which comprises a constellation modulation device 1010 configured to perform constellation modulation on data to be transmitted, and the modulation scheme of the constellation modulation presented in this embodiment is QAM or MPSK. The apparatus 1000 further includes a DFT device 1020 configured to perform a K-point DFT process on a vector composed of K constellation symbols resulting from the constellation modulation, where the parameter K represents the number of subcarriers allocated for transmission of the data to be transmitted. The is apparatus 1000 further comprises an OQAM modulation device 1030 configured to perform OQAM modulation on the data vector resulting from the DFT.

FIG. 11 illustrates an apparatus 1100 for reducing Peak-to-Average Power Ratio in a receiving device of a FBMC system according to an embodiment of the invention, which comprises an OQAM demodulation device configured to perform OQAM demodulation on a signal after channel equalization. The apparatus 1100 further comprises an IDFT device 1120 configured to perform K-point IDFT transform on the signal after the OQAM demodulation, wherein the parameter K represents the number of subcarriers allocated for the transmission of the corresponding data to be transmitted. The apparatus 1100 further comprises a constellation modulation demodulation device 1110 configured to perform constellation modulation demodulation on the signal after the IDFT transform, and a modulation scheme of constellation modulation presented in this embodiment is QAM or MPSK.

Those skilled in the art shall appreciate that the respective devices as referred to in the invention can be embodied as hardware modules, as software functional modules or as hardware modules integrated with software functional modules.

Those skilled in the art shall appreciate that the foregoing embodiments are illustrative but not limiting. Different technical features appearing in different embodiments can be combined to achieve advantages. Those skilled in the art shall appreciate and implement other variant embodiments of the disclosed embodiments upon reviewing the drawings, the description and the claims. In the claims, the term “comprising” will not preclude another device(s) or step(s); the indefinite article “a/an” will not preclude plural; and the terms “first”, “second”, etc., are intended to designate a name but not to represent any specific order. Any reference is numerals in the claims shall not be construed as limiting the scope of the invention. Functions of a plurality of parts appearing in a claim can be performed by a separate hardware software module. Some technical features appearing in different dependent claims will not mean that these technical features can not be combined to advantage.

1. A method of reducing Peak-to-Average Power Ratio in a transmitting device of a filter-bank multi-carrier system, comprising:
performing constellation modulation on data to be transmitted;
performing K-point Discrete Fourier Transform on a vector composed of K constellation symbols resulting from the constellation modulation; and
performing Offset-Quadrature Amplitude Modulation on a data vector resulting from the Discrete Fourier Transform,
wherein the parameter K represents the number of subcarriers allocated for transmission of the data to be transmitted.

2. The method according to claim 1, wherein performing Offset-Quadrature Amplitude Modulation on a data vector resulting from the Discrete Fourier Transform comprises mapping a real part of the data vector to a first filter-bank multi-carrier symbol and mapping an imaginary part of the data vector to a second filter-bank multi-carrier symbol.

3. The method according to claim 2, wherein a phase comprised in each element of the first and the second filter-bank multi-carrier symbols is determined by a time-domain index of the filter-bank multi-carrier symbol to which the element belongs and a frequency-domain index of a corresponding subcarrier.

4. The method according to claim 1, wherein the constellation modulation in performing constellation modulation on data to be transmitted is Multiple Phase-Shift Keying or Quadrature Amplitude Modulation.

5. The method according to claim 1, wherein after performing Offset-Quadrature Amplitude Modulation on a data vector resulting from the Discrete Fourier Transform, the method further comprises:
mapping filter-bank multi-carrier symbols onto the allocated K subcarriers through subcarrier mapping; and
performing multi-carrier filtering on an output of the subcarrier mapping.

6. The method according to claim 1, wherein the allocated K subcarriers are successive.

7. The method according to claim 5, wherein performing multi-carrier filtering on an output of the subcarrier mapping comprises:
performing M-point Inverse Discrete Fourier Transform on the output of the subcarrier mapping; and
performing a polyphase filtering process on the signal after the Inverse Discrete Fourier Transform,
wherein the parameter M represents the total number of subcarriers in the filter-bank multi-carrier system.

8. The method according to claim 1, wherein before performing constellation modulation on data to be transmitted, the method further comprises:
performing channel encoding on the data to be transmitted.

9. A method of reducing Peak-to-Average Power Ratio in a receiving device of a filter-bank multi-carrier system, comprising:
performing Offset-Quadrature Amplitude Modulation demodulation on a signal after channel equalization;
performing K-point Inverse Discrete Fourier Transform on the signal after the Offset-Quadrature Amplitude Modulation demodulation; and
performing constellation modulation demodulation on the signal after the Inverse Discrete Fourier Transform,
wherein the parameter K represents the number of subcarriers allocated for transmission of corresponding data to be transmitted.

10. The method according to claim 9, wherein before performing K-point Inverse Discrete Fourier Transform on the signal after the Offset-Quadrature Amplitude Modulation demodulation, the method further comprises:
performing multi-carrier filtering on a received signal;
performing subcarrier inverse mapping on the signal after the multi-carrier filtering; and
performing the channel equalization on the signal after the subcarrier inverse mapping.

11. The method according to claim 10, wherein performing multi-carrier filtering on a received signal comprises:
performing polyphase filtering on the received signal; and
performing M-point Discrete Fourier Transform on the signal after the polyphase filtering,
wherein the parameter M represents the total number of subcarriers in the filter-bank multi-carrier system.

12. The method according to claim 9, wherein the constellation modulation in performing constellation modulation demodulation on the signal after the Inverse Discrete Fourier Transform is Multiple Phase-Shift Keying or Quadrature Amplitude Modulation.

13. The method according to claim 9, wherein after performing constellation modulation demodulation on the signal after the Inverse Discrete Fourier Transform, the method further comprises:
performing channel decoding on the signal after the constellation modulation demodulation.

14. An apparatus for reducing Peak-to-Average Power Ratio in a transmitting device of a filter-bank multi-carrier system, comprising:
a constellation modulation device configured to perform constellation modulation on data to be transmitted;
a Discrete Fourier Transform device configured to perform K-point Discrete Fourier Transform on a vector composed of K constellation symbols resulting from the constellation modulation; and
an Offset-Quadrature Amplitude Modulation device configured to perform Offset-Quadrature Amplitude Modulation on a data vector resulting from the Discrete Fourier Transform,
wherein the parameter K represents the number of subcarriers allocated for transmission of the data to be transmitted.

15. An apparatus for reducing Peak-to-Average Power Ratio in a receiving device of a filter-bank multi-carrier system, comprising:
an Offset-Quadrature Amplitude Modulation demodulation device configured to perform Offset-Quadrature Amplitude Modulation demodulation on a signal after channel equalization;
an Inverse Discrete Fourier Transform device configured to perform K-point Inverse Discrete Fourier Transform on the signal after the Offset-Quadrature Amplitude Modulation demodulation; and
a constellation modulation demodulation device configured to perform constellation modulation demodulation on the signal after the Inverse Discrete Fourier Transform,
wherein the parameter K represents the number of subcarriers allocated for transmission of corresponding data to be transmitted.
